(19) United States
(12) Patent Application Publication
(10) Pub. No.: US 2025/0279817 A1
(43) Pub. Date: Sep. 4, 2025

(54) ANTENNA PORT GROUP INFORMATION REPORTING

(71) Applicant: Telefonaktiebolaget LM Ericsson (publ), Stockholm (SE)

(72) Inventors: Andreas Nilsson, Göteborg (SE); Sven Jacobsson, Västra Frölunda (SE)

(21) Appl. No.: 18/858,804

(22) PCT Filed: Apr. 28, 2023
(86) PCT No.: PCT/IB2023/054459

§ 371 Date: Oct. 22, 2024

Related U.S. Application Data
(60) Provisional application No. 63/336,535, filed on Apr. 29, 2022.

(51) Int. Cl. H04B 7/06; H04B 7/10

(52) U.S. Cl. CPC H04B 7/0691; H04B 7/0639; H04B 7/10

(57) ABSTRACT

A communication device (12) transmits, for each of one or more antenna port groups (18-1 . . . 18-N) into which antenna ports (16) of the communication device (12) are grouped, information (20-1 . . . 20-N) characterizing the antenna port group (18-1 . . . 18-N). In some embodiments, the information (20-1 . . . 20-N) characterizing the antenna port group (18-1 . . . 18-N) includes information indicating into how many columns antenna ports (16) in the antenna port group (18-1 . . . 18-N) are arranged and/or information indicating into how many rows antenna ports (16) in the antenna port group (18-1 . . . 18-N) are arranged. In other embodiments, the information (20-1 . . . 20-N) characterizing the antenna port group (18-1 . . . 18-N) alternatively or additionally includes information indicating a maximum oversampling factor supported by the antenna port group (18-1 . . . 18-N). In yet other embodiments, the information (20-1 . . . 20-N) characterizing the antenna port group (18-1 . . . 18-N) alternatively or additionally includes information indicating a coherence capability of the one or more antenna ports (16) included in the antenna port group (18-1 . . . 18-N) as being fully coherent and non-coherent.

### RELATED APPLICATIONS

The present application claims priority to U.S. Provisional Application No. 63/336,535, filed Apr. 29, 2022, which is incorporated herein by reference in its entirety.

### TECHNICAL FIELD

The present application relates generally to a communication network, and relates more particularly to antenna port group information reporting in such a network.

### BAKGROUND

Legacy New Radio (NR) codebook-based (CB-based) uplink transmission is limited to up to 4 antenna ports (and up to 4 spatial layers). Challenges exist in how to support up to 8 ports (and possibly more than 4 spatial layers) for uplink (UL) transmission, e.g., targeting Consumer Premises Equipment (CPE), Fixed Wireless Access (FWA) devices, vehicles, or industrial devices. This is the case especially given that different 8 transmit (TX) antenna port user equipment (UE) devices may be equipped with different UE TX antenna architectures.

### SUMMARY

Some embodiments herein accommodate different 8 TX UE devices being equipped with different UE TX antenna architectures. Notably in this regard, since an optimal or preferred UL codebook design depends on the UE antenna architecture, some embodiments herein facilitate different UEs being configurable with different UL codebooks in dependence on their UE TX antenna architecture, to optimize the UL performance. In order for the network to configure an 8 TX UE with a suitable codebook, the network may determine how the UE antenna architecture might look.

More particularly, in some embodiments, an 8 TX UE may be equipped with one or more antenna groups, where different antenna groups may be designed in different ways. Here, an antenna group may refer to an antenna port group as used herein. Indeed, in some embodiments, different antenna groups may have different number of antenna elements, different placements of the antenna elements, different coherency capability between the elements within an antenna group, etc. An antenna element here may refer to or correspond to an antenna port.

Since an antenna group can be designed in different ways, some embodiments herein signal the properties of an antenna group from the UE to the network, e.g., so that the gNB can determine a suitable UL codebook design to configure the UE with. Some embodiments herein accordingly provide one or more approaches on what to signal and how to signal it.

More particularly, embodiments herein include a method performed by a communication device configured for use in a communication network. The method comprises transmitting, for each of one or more antenna port groups into which antenna ports of the communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In yet other embodiments, the information characterizing the antenna port group alternatively or additionally includes information indicating a coherence capability of the one or more antenna ports included in the antenna port group as being fully coherent and non-coherent.

Other embodiments herein include a network node configured for use in a communication network. The method comprises receiving, for each of one or more antenna port groups into which antenna ports of a communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In yet other embodiments, the information characterizing the antenna port group alternatively or additionally includes information indicating a coherence capability of the one or more antenna ports included in the antenna port group as being fully coherent and non-coherent.

Other embodiments herein include a communication device configured for use in a communication network. The communication device is configured to transmit, for each of one or more antenna port groups into which antenna ports of the communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In other embodiments, the information characterizing the antenna port group alternatively or additionally includes information indicating a coherence capability of the one or more antenna ports included in the antenna port group as being fully coherent and non-coherent.

Other embodiments herein include a network node configured for use in a communication network. The network node is configured to receive, for each of one or more antenna port groups into which antenna ports of a communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In yet other embodiments, the information characterizing the antenna port group alternatively or additionally includes information indicating a coherence capability of the one or more antenna ports included in the antenna port group as being fully coherent and non-coherent.

Other embodiments herein include a communication device configured for use in a communication network. The communication device comprises communication circuitry and processing circuitry. The processing circuitry is configured to transmit, via the communication circuitry, for each of one or more antenna port groups into which antenna ports of the communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In yet other embodiments, the information characterizing the antenna port group alternatively or additionally includes information indicating a coherence capability of the one or more antenna ports included in the antenna port group as being fully coherent and non-coherent.

Other embodiments herein include a network node configured for use in a communication network. The network node comprises communication circuitry and processing circuitry. The processing circuitry is configured to receive, via the communication circuitry, for each of one or more antenna port groups into which antenna ports of a communication device are grouped, information characterizing the antenna port group. In some embodiments, the information characterizing the antenna port group includes information indicating into how many columns antenna ports in the antenna port group are arranged and/or information indicating into how many rows antenna ports in the antenna port group are arranged. In other embodiments, the information characterizing the antenna port group alternatively or additionally includes information indicating a maximum oversampling factor supported by the antenna port group. In yet other embodiments, the information characterizing the antenna port group alternatively or additionally includes information indicating a coherence capability of the one or more antenna ports included in the antenna port group as being fully coherent and non-coherent.

Embodiments herein also include corresponding apparatus, computer programs, and carriers of the computer programs. For example, some embodiments include a communication device configured for use in a communication network. The communication device is configured to transmit, for each of one or more antenna port groups into which antenna ports of the communication device are grouped, information characterizing the antenna port group.

Embodiments also include a network node configured for use in a communication network. The network node is configured to receive, for each of one or more antenna port groups into which antenna ports of a communication device are grouped, information characterizing the antenna port group.

### BRIEF DESCRIPTION OF THE DRAWINGS

FIG. 1 is a block diagram of a communication network in accordance with some embodiments.

FIG. 2 is a block diagram of an SRS resource allocated in time and frequency within a slot according to some embodiments.

FIG. 3 is a block diagram of an antenna architecture according to some embodiments.

FIG. 4 is a block diagram of an antenna architecture according to other embodiments.

FIG. 5 is a block diagram of an antenna architecture according to yet other embodiments.

FIG. 6 is a call flow diagram of antenna group information reporting according to some embodiments.

FIG. 7 is a logic flow diagram of a method performed by a communication device according to some embodiments.

FIG. 8 is a logic flow diagram of a method performed by a network node according to some embodiments.

FIG. 9 is a block diagram of a communication system in accordance with some embodiments.

FIG. 10 is a block diagram of a user equipment according to some embodiments.

FIG. 11 is a block diagram of a network node according to some embodiments.

FIG. 12 is a block diagram of a host according to some embodiments.

FIG. 13 is a block diagram of a virtualization environment according to some embodiments.

FIG. 14 is a block diagram of a host communicating via a network node with a UE over a partially wireless connection in accordance with some embodiments.

### DETAILED DESCRIPTION

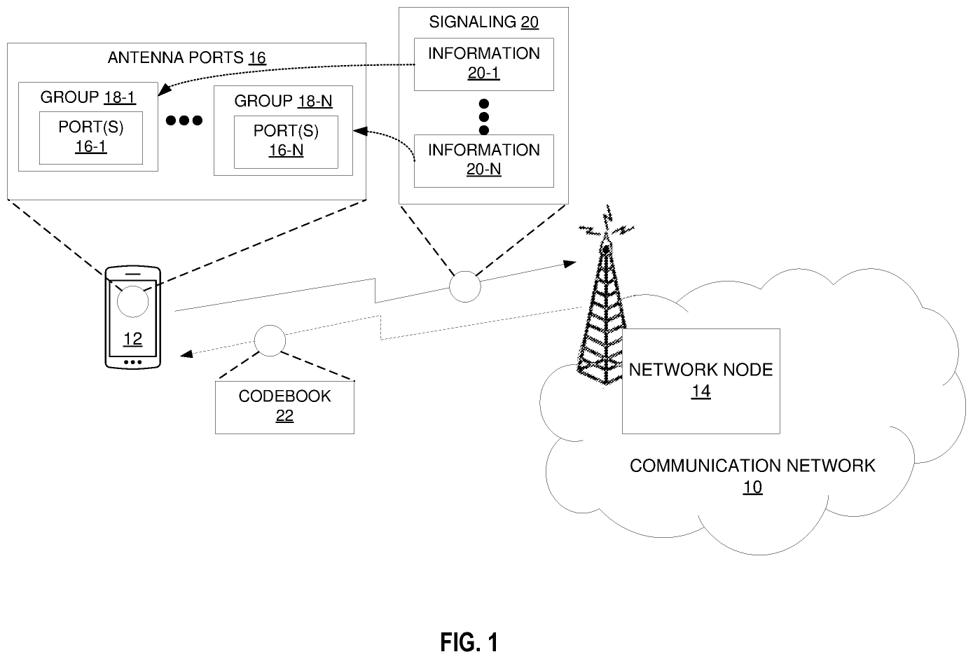

FIG. 1 shows a communication network 10 according to some embodiments. As shown, the communication network 10 includes a network node 14 that provides communication service to a communication device 12, e.g., a user equipment (UE) or a Fixed Wireless Access (FWA) device or a Customer Premises Equipment (CPE) device. The network node 14 may for instance be a radio network node, such as a base station, or be, control, or otherwise be associated with a transmission reception point (TRP). The network node 14 may provide such communication service to the communication device 12 in the capacity as a serving network node, e.g., that provides one or more serving cells of the communication device 12.

According to FIG. 1, the communication device 12 has or is configured with multiple antenna ports 16, e.g., transmit (TX) antenna ports. Each antenna port 16 is defined such that the channel over which a symbol on the antenna port is conveyed can be inferred from the channel over which another symbol on the same antenna port is conveyed. That is, two transmitted signals have experienced the same radio channel if and only if they are transmitted from the same antenna port.

An antenna port 16 can be a logical antenna port or a physical antenna port. With regard to logical antenna ports, the mapping of antenna port 16 to physical antenna is controlled by beam forming as a certain beam needs to transmit the signal on certain antenna ports to form a desired beam. So there is a possibility that two antenna ports are mapped to one physical antenna port or a single antenna port is mapped to multiple physical antenna ports.

In any event, FIG. 1 shows that antenna ports 16 of the communication device 12 are groupable into one or more antenna port groups 18-1 . . . 18-N. As shown, for example, the antenna ports 16 include port(s) 16-1 grouped into a first antenna port group 18-1, antenna port(s) 16-N grouped into an Nth antenna port group 18-N, etc. Different antenna port groups may have different numbers of antenna ports, different placements of the antenna ports, different coherency capability between the antenna ports within an antenna group, etc.

FIG. 1 shows that the communication device 12 transmits signaling 20 to the network node 14 characterizing one or more of its antenna port group(s), e.g., in terms of the properties of the antenna port groups on a group by group basis. Such signaling may assist the network node 14 to determine an appropriate precoding codebook 22 to configure the communication device 12 with, e.g., with one codebook 22 common to all antenna port groups or multiple codebooks specific to respective ones of the antenna port groups.

More particularly, FIG. 1 shows that the communication device 12 transmits, for each of one or more antenna port groups 18-1 . . . 18-N into which the antenna ports 16 of the communication device 12 are grouped, information 20-1 . . . 20-N characterizing the antenna port group, e.g., characterizing one or more properties of the antenna port group. As shown, for instance, information 20-1 characterizes antenna port group 18-1, information 20-N characterizes antenna port group 18-N, etc.

In some embodiments, the information 20-1 . . . 20-N characterizing the antenna port group 18-1 . . . 18-N includes information characterizing one or more properties of the antenna port group.

In some embodiments, the information 20-1 . . . 20-N characterizing the antenna port group 18-1 . . . 18-N comprises information indicating how many antenna ports are included in the antenna port group.

In some embodiments, the information 20-1 . . . 20-N characterizing the antenna port group 18-1 . . . 18-N comprises information indicating how many transmit chains are associated with the antenna port group.

In some embodiments, the information 20-1 . . . 20-N characterizing the antenna port group 18-1 . . . 18-N comprises information indicating into how many columns antenna ports in the antenna port group are arranged.

In some embodiments, the information 20-1 . . . 20-N characterizing the antenna port group 18-1 . . . 18-N comprises information indicating into how many rows antenna ports in the antenna port group are arranged.

In some embodiments, the information 20-1 . . . 20-N characterizing the antenna port group 18-1 . . . 18-N comprises information indicating into how many orthogonal polarizations antenna ports in the antenna port group are arranged.

In some embodiments, the information 20-1 . . . 20-N characterizing the antenna port group 18-1 . . . 18-N comprises information indicating a maximum oversampling factor supported by the antenna port group.

In some embodiments, the information 20-1 . . . 20-N characterizing the antenna port group 18-1 . . . 18-N comprises information indicating whether one or more antenna ports included in the antenna port group are arranged in a non-linear array or a non-planar array.

In some embodiments, the information 20-1 . . . 20-N characterizing the antenna port group 18-1 . . . 18-N comprises information indicating a set of precoding weights supported by the antenna port group.

In some embodiments, the information 20-1 . . . 20-N characterizing the antenna port group 18-1 . . . 18-N comprises information indicating a coherence capability of one or more antenna ports included in the antenna port group.

Note, though, in some embodiments, the one or more antenna port groups 18-1 . . . 18-N include one or more types of antenna port groups. In this case, the information 20-1 . . . 20-N may characterize the antenna port groups 18-1 . . . 18-N on a type by type basis. That is, the communication device 12 may transmit, for each of the one or more types of antenna port groups, information characterizing each antenna port group of that type.

Some embodiments herein are applicable in the following context, where the communication network 10 is exemplified as a 5G network or New Radio (NR) network, the communication device 12 is exemplified as a UE, and the network node 14 is exemplified as a gNB.

### UL Transmission/Precoding Schemes

In some embodiments, the channel that carries data in the NR UL is called Physical Uplink Shared Channel (PUSCH). In NR, there are two possible waveforms that can be used for PUSCH. One waveform is Cyclic Prefix (CP) Orthogonal Frequency Division Multiplexing (OFDM), referred to as CP-OFDM. The other waveform is Discrete Fourier Transform (DFT) OFDM, referred to as DFT-S-OFDM. Also, there are two transmission schemes specified for PUSCH: codebook (CB) based precoding, referred to as CB-based precoding, and non CB-based (NCB) precoding, referred to as NCB-based precoding.

The gNB configures, in Radio Resource Control (RRC), the transmission scheme through the higher-layer parameter txConfig in the PUSCH-Config IE. CB-based transmission can be used for non-calibrated UEs and/or for Frequency Division Duplexing (FDD) (i.e., UL/DL reciprocity does not need to hold). NCB-based transmission, on the other hand, relies on UL/DL reciprocity and is, hence, intended for Time Division Duplexing (TDD).

CB-based PUSCH is enabled if the higher-layer parameter txConfig is set to ‘codebook’. For dynamically scheduled PUSCH with configured grant type 2, CB-based PUSCH transmission can be summarized in the following steps according to some embodiments.

In a first step, the UE transmits a sounding reference signal (SRS), configured in an SRS resource set with higher-layer parameter usage in SRS-Config IE set to ‘codebook’. Up to two SRS resources (for testing up to two virtualizations/beams/panels) each with up to four ports, can be configured in the SRS resource set.

In the second step, the gNB determines the number of layers (or rank) and a preferred precoder (i.e., transmit precoder matrix indicator, TPMI) from a codebook subset based on the received SRS from one of the SRS resources. The codebook subset is configured via the higher-layer parameter codebookSubset, based on reported UE capability. Heretofore, the codebook subset is one of fully coherent (‘fullyAndPartialAndNonCoherent’), or partially coherent (‘partialAndNonCoherent’), or non-coherent (‘nonCoherent’).

In the third step, if two SRS resources are configured in the SRS resource set, the gNB indicates the selected SRS resource via a 1-bit Service Request Indicator (SRI) field in the Downlink Control Information (DCI) scheduling the PUSCH transmission. If only one SRS resource is configured in the SRS resource set, the SRI field is not indicated in DCI.

In the fourth step, the gNB indicates, via DCI, the number of layers and the TPMI. Demodulation Reference Signal (DM-RS) port(s) associated with the layer(s) are also indicated in DCI. The number of bits in DCI used for indicating the number of layers (if transform precoding is enabled, the number of PUSCH layers is limited to 1). The TPMI is determined as follows (unless UL full-power transmission is configured, for which the number of bits may vary). The TMPI is 4, 5, or 6 bits if the number of antenna ports is 4, if transform precoding is disabled, and if the higher-layer parameter maxRank in PUSCH-Config IE is set to 2, 3, or 4 (see Table 1). The TMPI is 2, 4, or 5 bits if the number of antenna ports is 4, if transform precoding is disabled or enabled, and if the higher-layer parameter maxRank in PUSCH-Config IE is set to 1 (see Table 2). The TMPI is 2 or 4 bits if the number of antenna ports is 2, if transform precoding is disabled, and if the higher-layer parameter maxRank in PUSCH-Config IE is set to 2 (see Table 3). The TMPI is 1 or 3 bits if the number of antenna ports is 2, if transform precoding is disabled or enabled, and if the higher-layer parameter maxRank in PUSCH-Config IE is set to 1 (see Table 4). And the TMPI is 0 bits if 1 antenna port is used for PUSCH transmission.

In the next step, the UE performs PUSCH transmission over the antenna ports corresponding to the SRS ports in the indicated SRS resource. Precoding information is provided in 3GPP TS 38.212, V16.9.0, section 7.3.1.1.2, for example.

For a given number of layers, the TPMI field indicates a precoding matrix that the UE should use for PUSCH.

NCB-based UL transmission is for reciprocity-based UL transmission in which SRS precoding is derived at a UE based on Channel State Information RS (CSI-RS) received in the DL. Specifically, the UE measures received CSI-RS and deduces suitable precoder weights for SRS transmission(s), resulting in one or more (virtual) SRS ports, each corresponding to a spatial layer.

A UE can be configured with up to four SRS resources, each with a single (virtual) SRS port, in an SRS resource set with higher-layer parameter usage in SRS-Config IE set to ‘nonCodebook’. A UE transmits the up to four SRS resources and the gNB measures the UL channel based on the received SRS and determines the preferred SRS resource(s). Next, the gNB indicates the selected SRS resources via the SRI field in DCI and the UE uses this information to precode PUSCH with a transmission rank that equals the number of indicated SRS resources (and, hence, the number of SRS ports).

### Sounding Reference Signal (SRS)

In some NR embodiments, SRS is used for providing channel state information (CSI) to the gNB in the UL. The usage of SRS includes, e.g., deriving the appropriate transmission/reception beams and/or to perform link adaptation (i.e., setting the transmission rank and the modulation and coding scheme, MCS), and for selecting DL (e.g., for Physical Downlink Shared Channel, PDSCH, transmissions) and UL (e.g., for PUSCH transmissions) Multiple-Input Multiple-Output (MIMO) precoding.

In some Long Term Evolution (LTE) and NR embodiments, the SRS is configured via RRC, where parts of the configuration can be updated (for reduced latency) through MAC-CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the Physical Downlink Control Channel (PDCCH) which instructs the UE to transmit the SRS once, at a predetermined time.

When configuring SRS transmissions, the gNB configures, through the SRS-Config IE, a set of SRS resources and a set of SRS resource sets, where each SRS resource set contains one or more SRS resources.

An SRS resource is configured in RRC (see e.g. 3GPP TS 38.331 version 16.1.0).

In some embodiments, an SRS resource is configurable with respect to one or more of the following.

In one example, an SRS resource is configurable with respect to the number of SRS ports (1, 2, or 4), configured by the RRC parameter nrofSRS-Ports.

In another example, an SRS resource is configurable with respect to the transmission comb (i.e., mapping to every 2^{nd} or 4^{th} subcarrier), configured by the RRC parameter transmissionComb, which includes: (i) the comb offset, configured by the RRC parameter combOffset, i.e., which of the combs that should be used; and/or (ii) the cyclic shift, configured by the RRC parameter cyclicShift. The cyclic shift configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts can be used (8 for comb 2 and 12 for comb 4).

In yet another example, an SRS resource is configurable with respect to the time-domain position within a given slot, configured with the RRC parameter resourceMapping. This includes (i) the time-domain start position, which is limited to be one of the last 6 symbols (in NR Rel-15) or in any of the 14 symbols in a slot (in NR Rel-16), configured by the RRC parameter startPosition; (ii) the number of symbols for the SRS resource (that can be set to 1, 2, or 4), configured by the RRC parameter nrofSymbols; and (iii) the repetition factor (that can be set to 1, 2, or 4), configured by the RRC parameter repetitionFactor. When the repetition factor is larger than 1, the same frequency resources are used multiple times across symbols, used to improve the coverage as this allows more energy to be collected by the receiver.

In still another example, an SRS resource is configurable with respect to the sounding bandwidth, frequency-domain position and shift, and frequency-hopping pattern of an SRS resource (i.e., which part of the transmission bandwidth that is occupied by the SRS resource. This may be set through the RRC parameters freqDomainPosition, freqDomainShift, and the freqHopping parameters c-SRS, b-SRS, and b-hop. The smallest possible sounding bandwidth is 4 RBs.

In another example, an SRS resource is configurable, via the RRC parameter resource Type, with respect to whether the SRS resource is transmitted as periodic, aperiodic (singe transmission triggered by DCI), or semi-persistent (same as periodic except the start and stop of the periodic transmission is controlled through MAC-CE signaling instead of RRC signaling).

In another example, an SRS resource is configurable, via the RRC parameter sequenceId, with respect to how the SRS sequence is initialized.

In another example, an SRS resource is configurable, via the RRC parameter spatialRelationInfo, the spatial relation for the SRS beam with respect to another RS (which could be another SRS, an SSB, or a CSI-RS). If an SRS resource has a spatial relation to another SRS resource, then this SRS resource should be transmitted with the same beam (i.e., virtualization) as the indicated SRS resource.

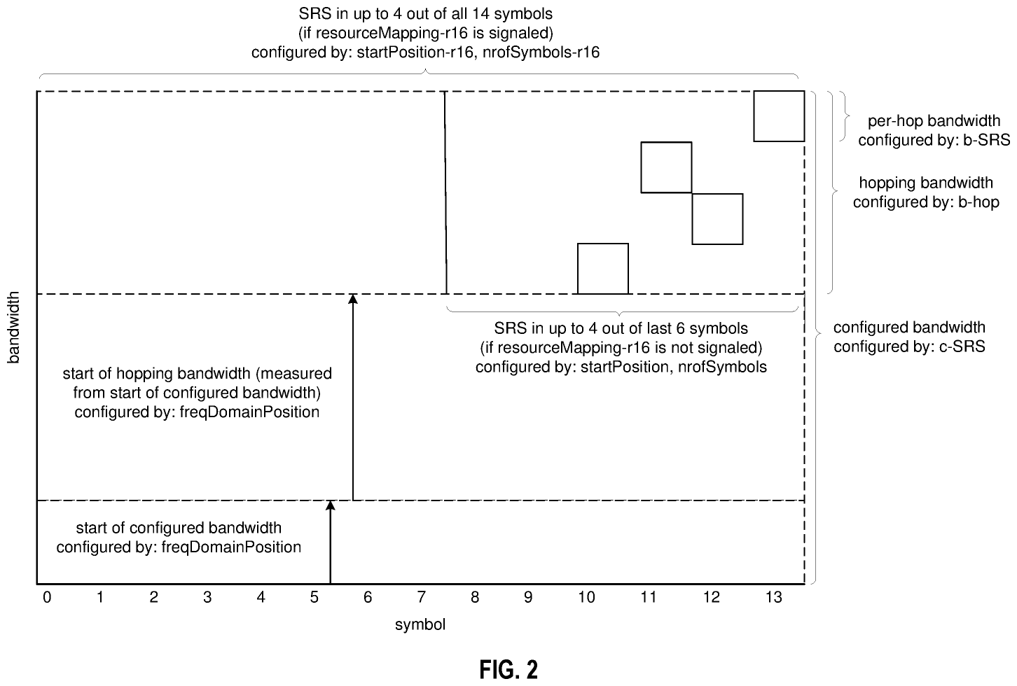

An illustration of how an SRS resource could be allocated in time and frequency within a slot (note that semi-persistent/periodic SRS resources typically span several slots), is provided in FIG. 2. In NR Rel-16, the additional (and optional) RRC parameter resourceMapping-r16 was introduced. If resourceMapping-r16 is signaled, the UE shall ignore the RRC parameter resourceMapping. The difference between resourceMapping-r16 and resourceMapping is that the SRS resource (for which the number of Orthogonal Frequency Division Multiplexing (OFDM) symbols and the repetition factor is still limited to 4) can start in any of the 14 OFDM symbols in a slot configured by the RRC parameter startPosition-r16.

In some embodiments, an SRS resource set is configured in RRC (see 3GPP TS 38.331 version 16.1.0, for example).

In some embodiments, SRS resource(s) will be transmitted as part of an SRS resource set, where all SRS resources in the same SRS resource set must share the same resource type. An SRS resource set is configurable with respect to one or more of the following.

For aperiodic SRS, the slot offset is configured by the RRC parameter slotOffset and sets the delay from the PDCCH trigger reception to the start of the SRS transmission.

The resource usage, which is configured by the RRC parameter usage sets constraints and assumptions on the resource properties (see 3GPP TS 38.214 V16.9.0 for further details). SRS resource sets can be configured with one of four different usages: ‘antennaSwitching’, ‘codebook’, ‘nonCodebook’, and ‘beamManagement’.

An SRS resource set that is configured with usage ‘antennaSwitching’ is used for reciprocity-based DL precoding (i.e., used to sound the channel in the UL so that the gNB can use reciprocity to set suitable DL precoders). The UE is expected to transmit one SRS port per UE antenna port.

An SRS resource set that is configured with usage ‘codebook’ is used for CB-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.

An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) the UE should apply for PUSCH transmission. One UL layer will be transmitted per indicated SRS resource. Note that how the UE maps SRS ports to antenna ports is up to UE implementation and not known to the gNB.

The associated CSI-RS (this configuration is only applicable for NCB-based UL transmission) for each of the possible resource types is as described below.

For an aperiodic SRS, the associated CSI-RS resource is set by the RRC parameter CSI-RS.

For semi-persistent/periodic SRS, the associated CSI-RS resource is set by the RRC parameter associated CSI-RS.

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

In this context, some embodiments herein advantageously facilitate support for up to 8 ports (and possible more than 4 layers) for UL transmission, as opposed to legacy NR CB-based UL transmission being limited to up to 4 ports (and up to 4 layers). Some embodiments in this regard facilitate UL DMRS, SRS, SRI, and TPMI (including codebook) enhancements to enable 8 Tx UL operation to support 4 or more layers per UE in UL, e.g., targeting CPE/FWA/vehicle/Industrial devices.

In a first example, a UE is configured with/has N_{TX} transmit ports. The N_{TX} transmit ports at the UE are split into N_{g} non-overlapping groups (i.e., subsets of the antenna ports {0,1, . . . , N_{TX}−1}) for which: (i) antenna ports within each group can be assumed to be coherent; and (ii) antenna ports in different groups cannot be assumed to be coherent.

In what follows, for illustration purposes, examples are provided of UE antenna-array architectures for the case when N_{TX}∈{6,8} UE (transmit-)antenna ports are split into N_{g} groups. Note that this is for illustration purposes only: embodiments herein are equally applicable for any number of antenna ports.

For simplicity of illustration, it is assumed that the antenna elements within an antenna group are dual polarized for the case when there is more than one antenna port in the group. Furthermore, it is assumed that antenna elements within a group are organized in a uniform array (i.e., a Uniform Linear Array (ULA) or a Uniform Planar Array (UPA)).

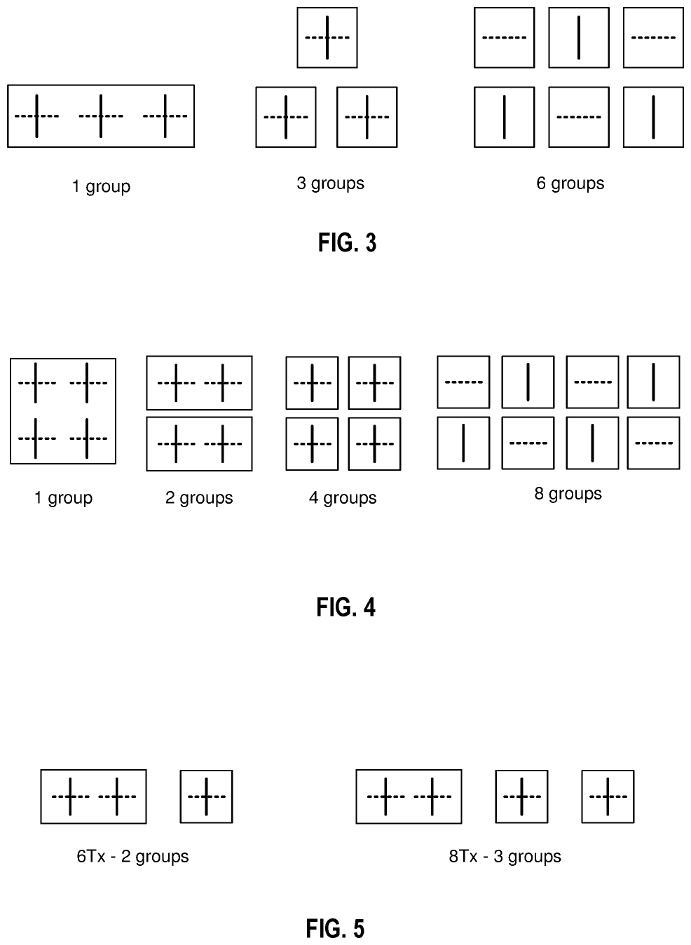

For example, it is assumed that all groups contain the same number of antenna ports. Under these assumptions, possible UE antenna architectures for a 6 Tx and an 8 Tx UE are shown in FIG. 3 and FIG. 4, respectively. In FIG. 3, N_{g}∈{1,3,6} for a 6 Tx UE. In other words, FIG. 3 shows the possible UE antenna architectures for a 6 Tx UE with 1, 3, or 6 groups. A first polarization (horizontal, in this example) is shown in dashed lines, and a second polarization (vertical, in this example) is shown in solid lines.

FIG. 4 illustrates the possible UE antenna architectures for an 8 Tx UE with 1, 2, 4, or 8 groups, i.e., N_{g}∈{1,2,4,8}. Here a first polarization (horizontal, in this example) is shown in dashed lines, and a second polarization (vertical, in this example) is shown in solid lines.

For each case (FIG. 3 or FIG. 4), there are N_{TX}/N_{g} ports in each group. Note that the different antenna-port groups may not be co-located and may be pointing in different directions.

Note that for 8 Tx (and with the assumptions above), there are two possible UE antenna-array architectures: A UPA (as in left part of FIG. 4) and a ULA. FIG. 4 only illustrates the UPA case for 8 Tx UE.

In one example, not all groups contain the same number of antenna ports. Two examples of such asymmetric UE architectures are provided in FIG. 5. Indeed, FIG. 5 illustrates UE architectures with asymmetric groups. Here a first polarization (horizontal, in this example) is shown in dashed lines, and a second polarization (vertical, in this example) is shown in solid lines.

In this case, all values N_{g}∈{1,2, . . . , N_{TX}} could be allowed, irrespective of the value of N_{TX}. However, there must be a common assumption between the network and the UE on which antenna ports belong to which group.

For example, for the case N_{TX}=6 and N_{g}=2 (see left part of FIG. 5), it may be assumed that the first four ports (e.g. the four SRS port with lowest SRS port number, e.g., {0,1,2,3}) belong to a first group (where the first group, for example, can be the antenna-port group with the most number of antenna ports) and the last two ports (i.e. the two SRS ports with highest SRS port number, e.g., {4,5}) belong to a second group (where the second group, for example, which could be the antenna-port group with the least number of antenna ports).

Hence, which SRS ports are associated with which antenna-port groups can be based on defining a certain order of the SRS ports and an order of the antenna-port groups and where there is an association between a first SRS port with a first antenna port of the first antenna group, a second SRS port with a second antenna port of the first antenna group, and so on until the all the antenna ports in the first antenna group are associated with an SRS port, then the next SRS port is associated with the first antenna port of a second antenna group and so on until all the antenna ports in all antenna-port groups have been associated with an SRS port. The ordering of the SRS ports can for example be based on the SRS port number (either in decreasing order or increasing order). The ordering of the antenna-port groups can be either based on an explicitly indicated antenna group number signaled during UE capability signaling or be based on the number of antenna ports there is in each antenna group (either in decreasing or increasing order based on the number of ports in each antenna group).

Since an antenna group can be designed in different ways, some embodiments herein signal the properties of an antenna group from the UE to the network, e.g., so that the gNB can determine a suitable UL codebook design to configure the UE with. Some embodiments herein accordingly provide one or more approaches on what to signal and how to signal it.

As used herein, an “antenna group” may consist either of: (i) all of the (transmit-)antenna ports of, e.g., a UE or CPE/FWA device, or (ii) a proper subset of the (transmit-)antenna ports of, e.g., a UE or CPE/FWA. An antenna group may be used interchangeably with an antenna port group.

Also as used herein, a “codebook” may refer to either of: (i) the set of candidate TPMIs per antenna group, or (ii) the set of candidate TPMIs over all antenna groups.

Certain embodiments may provide one or more of the following technical advantage(s). By indicating UE “Antenna group information” to the network, the network can configure the UE with precoding matrices from a suitable UL codebook, which will enhance the UL throughput/performance.

Furthermore, if the UE antenna architecture is known to the network, the cardinality of the set of precoding matrices can be minimized to include only relevant precoders, which, in turn, will reduce DL (DCI) overhead.

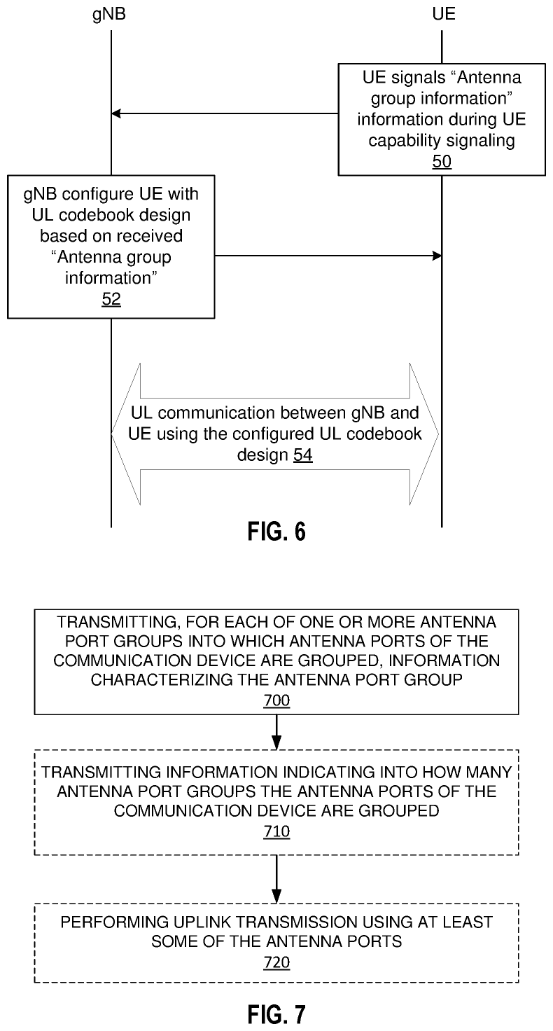

FIG. 6 illustrates a general flow chart according to some embodiments. In the first step (Block 50), the UE signals one or more “Antenna group information” to the gNB, for example during UE capability signaling. “Antenna group information” may exemplify the information 20-1 . . . 20-N for a certain antenna port group 18-1 . . . 18-N in FIG. 1, where an antenna group corresponds to an antenna port group in FIG. 1. In the next step (Block 52), the gNB configures the UE with a UL codebook that is suitable for the information received in the “Antenna group information” signaling. In the last step (Block 54), the gNB and UE performs UL communication based on the configured UL codebook.

In one embodiment, the “Antenna group information” contains one or more of the following information per antenna group (either explicitly or implicitly): (i) number of TX chains (or transmit antenna ports) in the antenna group (T); (ii) number of columns (N1) in the antenna group; (iii) number of rows (N2) in the antenna group; (iv) number of orthogonal polarizations (P) in the antenna group; (v) maximum supported horizontal (column) oversampling factor (O1); (vi) maximum supported vertical (row) oversampling factor (O2); (vii) indication of non-linear or non-planar array; (viii) indication of coherence capability of the TX antennas within the antenna group; (ix) indication of the supported set of precoding weights.

In one embodiment, the UE is equipped with a single antenna group, and therefore the UE only signals one copy of an “Antenna group information”. In another embodiment, the UE is equipped with multiple antenna groups, and the UE therefore signals multiple different copies of an “Antenna group information” (e.g., one copy per antenna group, or one copy per antenna group type, where multiple antenna groups with similar/same properties can belong to the same antenna group type). In one embodiment, the UE is equipped with multiple antenna groups, where all antenna groups have the same/similar properties, and the UE therefore signals a single copy of an “Antenna group information” that is applicable to all the antenna groups of the UE.

In one embodiment, the number of rows (N2) in the antenna group is implicitly indicated by dividing the number of reported TX chains per antenna group (T) with the number of columns (N1) times 2, i.e., N2=T/(2*N1). This could be useful to save signaling overhead during UE capability signaling if for example it is pre-determined (in the 3GPP specification) that each antenna group is equipped with dual-polarized antenna elements. In a similar way, N1 could be implicitly indicated instead of N2.

In one embodiment, the number of rows (N2) in the antenna group is implicitly indicated by dividing the number of reported TX chains (T) per antenna group with the number of columns (N1) times the number of indicated orthogonal polarizations (P), i.e., N2=T/(P*N1), which could be useful to save overhead signaling during UE capability signaling. In a similar way, N1 could be implicitly indicated instead of N2.

In one embodiment, the number of orthogonal polarizations (P) in the antenna group is implicitly indicated by dividing the number of reported TX chains per antenna group (T) with the number of columns (N1) times the number of rows (N2), i.e., P=T/(N1*N2). This could be useful to save signaling overhead during UE capability signaling.

In one embodiment, the number of TX chains in the antenna group is implicitly signaled by dividing the number of total TX chains of the UE (which might be signaled separately) with the number of reported antenna groups (which also might be signaled separately). This could be useful to save signaling overhead during UE capability signaling when all antenna groups are assumed to have the same number of TX chains.

In one embodiment, the number of antenna groups are implicitly reported to be 1, when no explicit signaling of number of antenna groups are reported.

In one embodiment, the UE can signal (with for example a single bit bitfield) if the antenna elements of a certain antenna group are arranged in a linear or planar equidistant way, or if the antenna elements in the array are not arranged in a linear or planar equidistant way. This could be useful since different codebooks are typically optimal depending on if the antenna elements in an antenna array are arranged in linear or planar equidistant way (typically Discrete Fourier Transform, DFT, codebook is preferred) or not (e.g., the UL Rel-15 NR codebook designs might be preferred).

In one embodiment, the UE can indicate a coherency capability for the antenna group. In one embodiment, the coherency capability is implicitly assumed to be “coherent” between antenna elements within one antenna group, but “non-coherent” between antenna elements belonging to different antenna groups. In one embodiment, if coherency capability is not indicated, the gNB should automatically assume “coherent” behavior between the antenna elements of the antenna group.

Based on other information signaled in “Antenna group information” during UE capability signaling, the gNB can configure the UE with one out of a set of UL codebook designs, where the set of UL codebook design supported by the UE is (at least partly) inferred from the information in the “Antenna group information”.

For example, if the information in the “Antenna group information” indicates that both N1>1 and N2>1 for an antenna group, the UE can be configured with a UL codebook targeting uniform planar arrays. In addition, depending on the horizontal and vertical oversampling factors O1 and O2, different numbers of beams might be included in the codebook, both in the horizontal and in the vertical domain. In one embodiment where O1∈{1,2} and O2∈{1,2}, all entries in the codebook are restricted to entries of a 4PSK alphabet.

If the information in the “Antenna group information” indicates that either N1<2 or N2<2 for an antenna group, the UE can be configured with a UL codebook targeting uniform linear arrays. In addition, depending on the horizontal and vertical oversampling factors O1 and O2, different numbers of beams might be included in the codebook. In one embodiment, if N1<=4, N2=1, O1=1 and O2=1, or if N1=1, N2<=4, O1=1, and O2=1, the codebook contains only 4PSK entries. In another embodiment, if N1=4, N2=1, O1=2 and O2=1, or if N1=1, N2=4, O1=1. and O2=2, the codebook contains only 8PSK entries.

In one embodiment, instead of reporting O1 and O2 for a given number of N1 and N2, the UE reports a supported set of precoding weights.

For example, the UE may indicate support for 4PSK entries from which the gNB can infer a supported set of UL codebooks from a larger set of candidate UL codebooks. Furthermore, the gNB can derive the resulting O1 and O2. Indeed, if N1=4 and N2=1, gNB knows that O1=1 and O2=1 since such oversampling factors results in 4PSK entries.

In another example, the UE may indicate support for 8PSK entries from which the gNB can infer a supported set of UL codebooks from a larger set of candidate UL codebooks. Furthermore, the gNB can derive the resulting O1 and O2. Indeed, if N1=4 and N2=1, gNB knows that O1=2 and O2=1 since such oversampling factors results in 8PSK entries.

In one embodiment, if the number of Tx chains in an antenna group is T=8, the UE can report whether the antenna elements in the group are configured in a ULA or in a UPA. If UE reports ‘ULA’, gNB knows that N1 and N2 are either N1=4 and N2=1 or N1=1 and N2=4. If UE reports ‘UPA, gNB knows that N1=2 and N2=2.

### Explicit Reporting of UE Coherence Capability

In one embodiment, the UE explicitly reports coherency capability for the antennas associated with one or more antenna-port groups during UE capability signaling. This could be useful, for example, if antenna-port groups are defined based on the antenna structure and not on the coherency capability.

In one embodiment, the UE reports coherency capability for one antenna port group, which then indicates the coherency capability between antenna elements belonging to the same antenna port group. For example, a UE might be equipped with two antenna-port groups with 4 antenna elements each, where the two antenna-port groups are pointing in opposite directions. In this case, the antenna elements in each antenna-port group can be either non-coherent, partially coherent, or fully coherent (and hence for example be configured with different sets of valid TPMIs).

In one embodiment, the UE reports coherency capability between two or more different antenna port groups, which then indicates the coherency capability between antenna elements belonging different antenna port groups.

In one embodiment, in addition to reporting the legacy coherent capabilities (within or between antenna port groups), the UE can also report the following coherency capabilities (for one or multiple antenna port groups):
“Fully coherent and partially coherent” means that the UE can be configured with a set of valid TPMI candidates associated with a fully coherent UE (e.g., a rank 1 precoder [1,1,1,1]), and partially coherent UE (e.g., a rank 1 precoder [1,0,1,0]) but without the TPMI candidates associated with non-coherent UE (e.g., a rank 1 precoder [1,0,0,0]).
“Fully coherent” means that the UE can be configured with a set of valid TPMI candidates associated with a fully coherent UE (e.g., a rank 1 precoder [1,1,1,1]), but without the TPMI candidates associated with a partially coherent UE (e.g., a rank 1 precoder [1,0,1,0]) and a non-coherent UE (e.g., a rank 1 precoder [1,0,0,0]).
“Partially coherent” means that the UE can be configured with a set of valid TPMI candidates associated with a partially coherent UE (e.g., a rank 1 precoder [1,0,1,0]) but without the TPMI candidates associated with a non-coherent UE (e.g., a rank 1 precoder [1,0,0,0]), and a fully coherent UE (e.g., a rank 1 precoder [1,1,1,1]).

The benefit with this embodiment is that the TPMI overhead can be reduced compared to legacy NR, since for example a fully coherent UE can be configured with a set of valid TPMIs that only is associated with a fully coherent UE (i.e., only port combining TPMIs).

In view of the modifications and variations herein, FIG. 7 depicts a method in accordance with particular embodiments. The method is performed by a communication device 12 configured for use in a communication network 10. The method includes transmitting, for each of one or more antenna port groups 18-1 . . . 18-N into which antenna ports 16 of the communication device 12 are grouped, information 20-1 . . . 20-N characterizing the antenna port group 18-1 . . . 18-N (Block 700).

In some embodiments, the method also includes transmitting information indicating into how many antenna port groups (N) the antenna ports 16 of the communication device 12 are grouped (Block 710).

Alternatively or additionally, in some embodiments, the method also includes performing uplink transmission using at least some of the antenna ports 16 (Block 720). In some embodiments, the method further comprises receiving a codebook 22 based on the information. In this case, the uplink transmission may be precoded based on the received codebook 22.

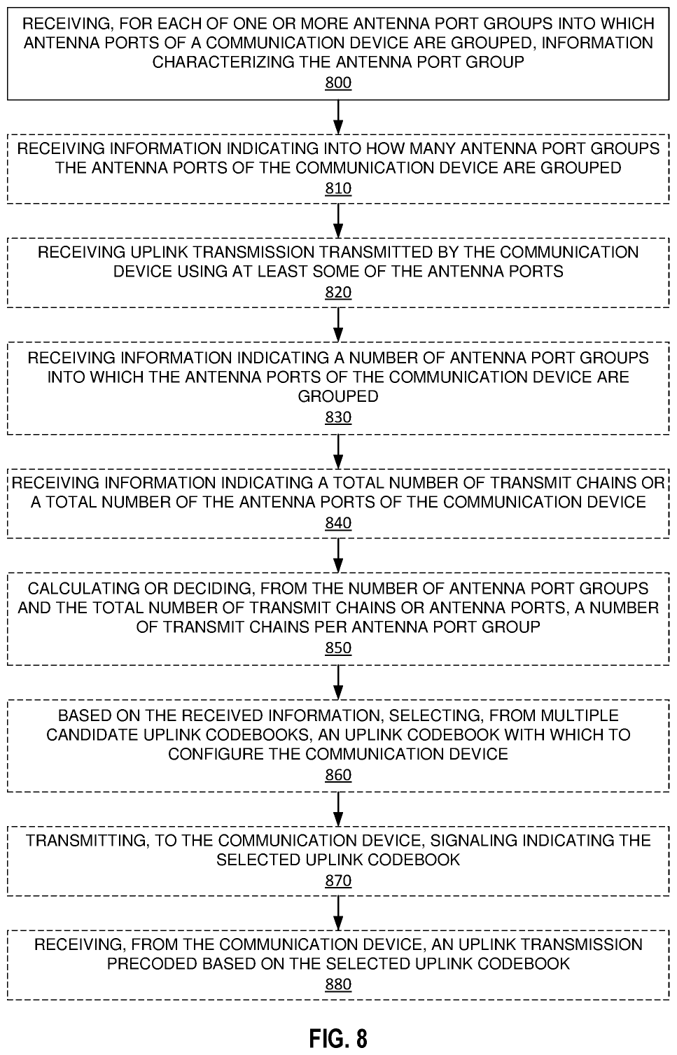

FIG. 8 depicts a method in accordance with other particular embodiments. The method is performed by a network node 14 configured for use in a communication network 10. The method includes receiving, for each of one or more antenna port groups 18-1 . . . 18-N into which antenna ports 16 of a communication device 12 are grouped, information 20-1 . . . 20-N characterizing the antenna port group 18-1 . . . 18-N (Block 800).

In some embodiments, the method also includes receiving information indicating into how many antenna port groups the antenna ports of the communication device are grouped (Block 810).

In some embodiments, the method also includes receiving uplink transmission transmitted by the communication device using at least some of the antenna ports (Block 820).

In some embodiments, the method also includes receiving information indicating a number of antenna port groups into which the antenna ports of the communication device are grouped (Block 830).

In some embodiments, the method also includes receiving information indicating a total number of transmit chains or a total number of the antenna ports of the communication device (Block 840).

In some embodiments, the method also includes calculating or deciding, from the number of antenna port groups and the total number of transmit chains or antenna ports, a number of transmit chains per antenna port group (Block 850).

In some embodiments, the method also includes, based on the received information, selecting, from multiple candidate uplink codebooks, an uplink codebook with which to configure the communication device (Block 860).

In some embodiments, the method also includes transmitting, to the communication device, signaling indicating the selected uplink codebook (Block 870).

In some embodiments, the method also includes receiving, from the communication device, an uplink transmission precoded based on the selected uplink codebook (Block 880).

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a UE. The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

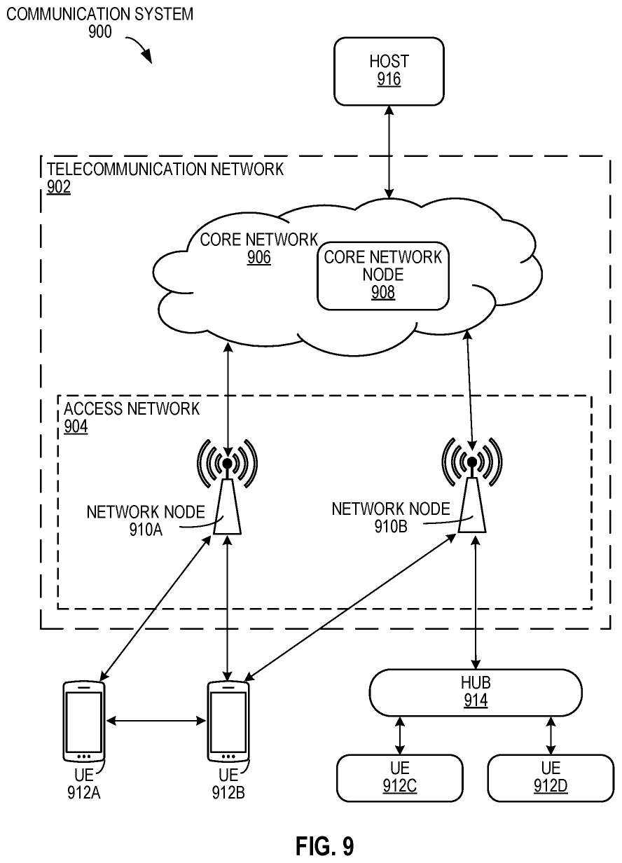

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3GPP access node or non-3GPP access point. The network nodes 910 facilitate direct or indirect connection of UE, such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); LTE, and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

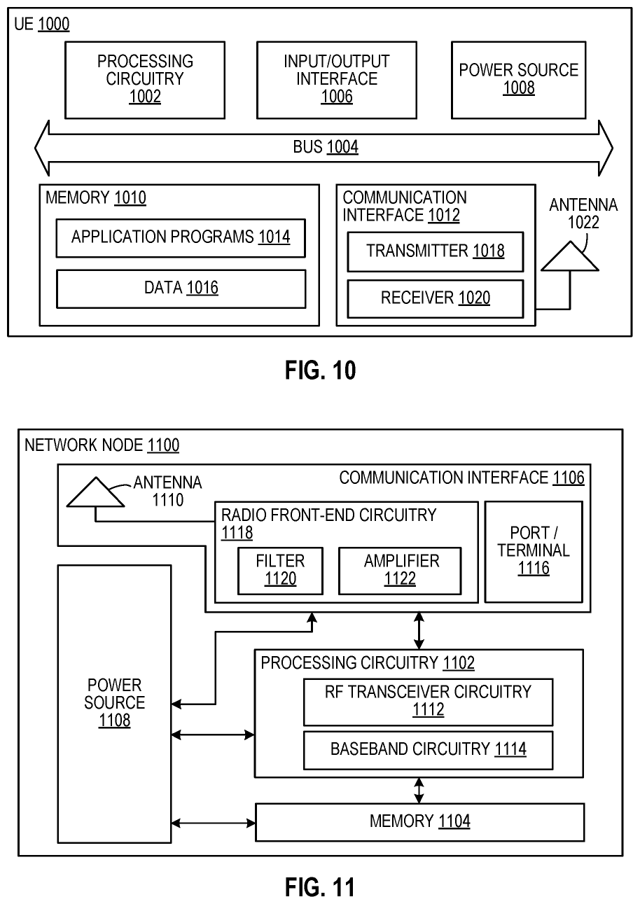

FIG. 10 shows a UE 1000 in accordance with some embodiments. The UE 1000 may incorporate the communication device 12 in some embodiments as described herein and/or may be configured to perform the method in FIG. 7. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node.

As another example, a UE comprises an actuator, a motor, or a switch, related to a communication interface configured to receive wireless input from a network node via a wireless connection. In response to the received wireless input the states of the actuator, the motor, or the switch may change.

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, any kind of medical device, like a heart rate monitor or a remote controlled surgical robot, etc. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. The network node 1100 may correspond to the network node 14 in FIG. 1 and/or be configured to perform the method in FIG. 8. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

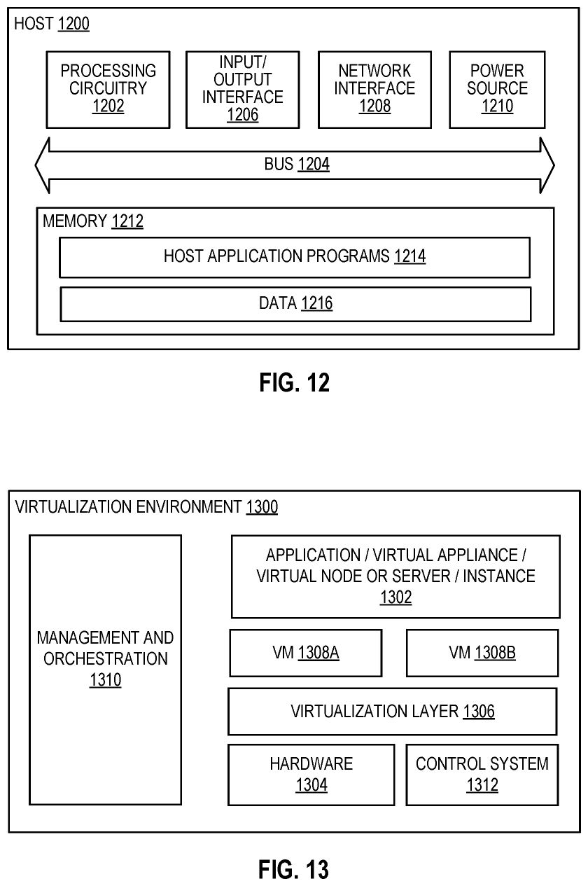

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

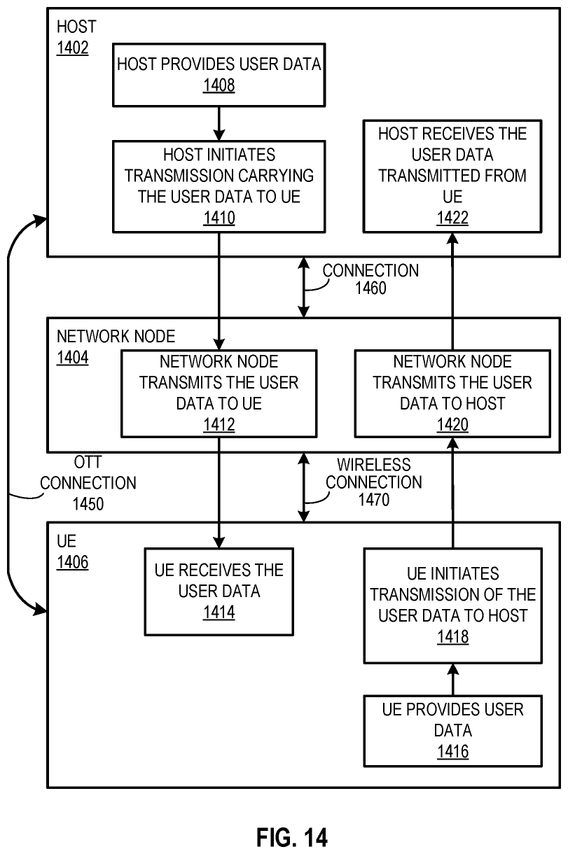

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams, etc., from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-44. (canceled)

45. A method performed by a user equipment configured for use in a communication network, the method comprising:
transmitting, for each of one or more antenna port groups into which antenna ports of the user equipment are grouped, information characterizing the antenna port group, wherein the information characterizing the antenna port group includes information indicating a coherence capability of one or more antenna ports included in the antenna port group as being fully coherent or as being partially coherent; and
receiving, from the communication network, signaling indicating an uplink codebook which consists only of a set of candidate transmit precoding matrices associated with a fully coherent user equipment or which consists only of a set of candidate transmit precoding matrices associated with a partially coherent user equipment.

46. The method of claim 45, wherein the information characterizing an antenna port group includes information indicating a coherence capability of one or more antenna ports included in the antenna port group as being fully coherent, meaning that the one or more antenna ports included in the antenna port group are capable of being configured with an uplink codebook which consists of a set of candidate transmit precoding matrices associated with a fully coherent user equipment and which excludes candidate transmit precoding matrices associated with a partially coherent user equipment and excludes candidate transmit precoding matrices associated with a non-coherent user equipment, and wherein the received signaling indicates an uplink codebook which consists only of a set of candidate transmit precoding matrices associated with a fully coherent user equipment.

47. The method of claim 45, wherein the information characterizing an antenna port group includes information indicating a coherence capability of one or more antenna ports included in the antenna port group as being partially coherent, meaning that the one or more antenna ports included in the antenna port group are capable of being configured with an uplink codebook which consists of a set of candidate transmit precoding matrices associated with a partially coherent user equipment and which excludes candidate transmit precoding matrices associated with a fully coherent user equipment and excludes candidate transmit precoding matrices associated with a non-coherent user equipment, and wherein the received signaling indicates an uplink codebook which consists only of a set of candidate transmit precoding matrices associated with a partially coherent user equipment.

48. The method of claim 45, wherein the information characterizing the antenna port group further includes one or more of:
information indicating into how many columns antenna ports in the antenna port group are arranged;
information indicating into how many rows antenna ports in the antenna port group are arranged;
information indicating a maximum oversampling factor supported by the antenna port group;
information indicating how many transmit chains are associated with the antenna port group; and/or
information indicating into how many orthogonal polarizations antenna ports in the antenna port group are arranged.

49. The method of claim 45, wherein the information characterizing the antenna port group further comprises:
information indicating whether one or more antenna ports included in the antenna port group are arranged in a non-linear array or a non-planar array; and/or
information indicating whether or not antenna ports included in the antenna port group are arranged in a linear or planar equidistance way.

50. The method of claim 45, wherein the information characterizing the antenna port group further comprises information indicating a set of precoding weights supported by the antenna port group.

51. The method of claim 45, further comprising transmitting information indicating into how many antenna port groups the antenna ports of the user equipment are grouped.

52. A user equipment configured for use in a communication network, the user equipment comprising:
communication circuitry; and
processing circuitry configured to:
transmit, via the communication circuitry, for each of one or more antenna port groups into which antenna ports of the user equipment are grouped, information characterizing the antenna port group, wherein the information characterizing the antenna port group includes information indicating a coherence capability of the one or more antenna ports included in the antenna port group as being fully coherent or as being partially coherent; and
receive, from the communication network, signaling indicating an uplink codebook which consists only of a set of candidate transmit precoding matrices associated with a fully coherent user equipment or which consists only of a set of candidate transmit precoding matrices associated with a partially coherent user equipment.

53. The user equipment of claim 52, wherein the information characterizing an antenna port group includes information indicating a coherence capability of one or more antenna ports included in the antenna port group as being fully coherent, meaning that the one or more antenna ports included in the antenna port group are capable of being configured with an uplink codebook which consists of a set of candidate transmit precoding matrices associated with a fully coherent user equipment and which excludes candidate transmit precoding matrices associated with a partially coherent user equipment and excludes candidate transmit precoding matrices associated with a non-coherent user equipment, and wherein the received signaling indicates an uplink codebook which consists only of a set of candidate transmit precoding matrices associated with a fully coherent user equipment.

54. The user equipment of claim 52, wherein the information characterizing an antenna port group includes information indicating a coherence capability of one or more antenna ports included in the antenna port group as being partially coherent, meaning that the one or more antenna ports included in the antenna port group are capable of being configured with an uplink codebook which consists of a set of candidate transmit precoding matrices associated with a partially coherent user equipment and which excludes candidate transmit precoding matrices associated with a fully coherent user equipment and excludes candidate transmit precoding matrices associated with a non-coherent user equipment, and wherein the received signaling indicates an uplink codebook which consists only of a set of candidate transmit precoding matrices associated with a partially coherent user equipment.

55. The user equipment of claim 52, wherein the information characterizing the antenna port group further includes one or more of:
information indicating into how many columns antenna ports in the antenna port group are arranged;
information indicating into how many rows antenna ports in the antenna port group are arranged;
information indicating a maximum oversampling factor supported by the antenna port group;
information indicating how many transmit chains are associated with the antenna port group; and/or
information indicating into how many orthogonal polarizations antenna ports in the antenna port group are arranged.

56. The user equipment of claim 52, wherein the information characterizing the antenna port group further comprises:
information indicating whether one or more antenna ports included in the antenna port group are arranged in a non-linear array or a non-planar array; and/or
information indicating whether or not antenna ports included in the antenna port group are arranged in a linear or planar equidistance way.

57. The user equipment of claim 52, wherein the information characterizing the antenna port group further comprises information indicating a set of precoding weights supported by the antenna port group.

58. The user equipment of claim 52, wherein the processing circuitry is further configured to transmit information indicating into how many antenna port groups the antenna ports of the user equipment are grouped.

59. A method performed by a network node configured for use in a communication network, the method comprising:
receiving, for each of one or more antenna port groups into which antenna ports of a user equipment are grouped, information characterizing the antenna port group, wherein the information characterizing the antenna port group includes information indicating a coherence capability of the one or more antenna ports included in the antenna port group as being fully coherent or as being partially coherent; and
based on the received information, transmitting, to the user equipment, signaling indicating an uplink codebook which consists only of a set of candidate transmit precoding matrices associated with a fully coherent user equipment or which consists only of a set of candidate transmit precoding matrices associated with a partially coherent user equipment.

60. The method of claim 59, wherein the information characterizing an antenna port group includes information indicating a coherence capability of one or more antenna ports included in the antenna port group as being fully coherent, meaning that the one or more antenna ports included in the antenna port group are capable of being configured with an uplink codebook which consists of a set of candidate transmit precoding matrices associated with a fully coherent user equipment and which excludes candidate transmit precoding matrices associated with a partially coherent user equipment and excludes candidate transmit precoding matrices associated with a non-coherent user equipment, and wherein the transmitted signaling indicates an uplink codebook which consists only of a set of candidate transmit precoding matrices associated with a fully coherent user equipment.

61. The method of claim 59, wherein the information characterizing an antenna port group includes information indicating a coherence capability of one or more antenna ports included in the antenna port group as being partially coherent, meaning that the one or more antenna ports included in the antenna port group are capable of being configured with an uplink codebook which consists of a set of candidate transmit precoding matrices associated with a partially coherent user equipment and which excludes candidate transmit precoding matrices associated with a fully coherent user equipment and excludes candidate transmit precoding matrices associated with a non-coherent user equipment, and wherein the transmitted signaling indicates an uplink codebook which consists only of a set of candidate transmit precoding matrices associated with a partially coherent user equipment.

62. The method of claim 59, wherein the information characterizing the antenna port group further includes one or more of:
information indicating into how many columns antenna ports in the antenna port group are arranged;
information indicating into how many rows antenna ports in the antenna port group are arranged;
information indicating a maximum oversampling factor supported by the antenna port group;
information indicating how many transmit chains are associated with the antenna port group; and/or
information indicating into how many orthogonal polarizations antenna ports in the antenna port group are arranged.

63. The method of claim 59, wherein the information characterizing the antenna port group further comprises:
information indicating whether one or more antenna ports included in the antenna port group are arranged in a non-linear array or a non-planar array; and/or
information indicating whether or not antenna ports included in the antenna port group are arranged in a linear or planar equidistance way.

64. The method of claim 59, wherein the information characterizing the antenna port group further comprises information indicating a set of precoding weights supported by the antenna port group.
